(19) United States
(12) Patent Application Publication
(10) Pub. No.: US 2009/0198943 A1
(43) Pub. Date: Aug. 6, 2009

(54) Semiconductor Exposure Apparatus, Control Method, and Computer-Readable Storage Medium

(75) Inventor: Hideyuki Yahagi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/359,498

(22) Filed: Jan. 26, 2009

(30) Foreign Application Priority Data
Jan. 31, 2008 (JP) 2008-021649

(51) Int. Cl. G06F 12/02

(52) U.S. Cl. 711/170; 711/E12.002

(57) ABSTRACT

A semiconductor exposure apparatus which executes a plurality of jobs each including at least one application program is provided. The apparatus includes a memory configured to be used to execute the application program, an application program execution management unit configured to manage execution of the application program included in the job; and a memory access management unit configured to manage a memory area to be allocated to the application program using a table in which the job including the application program, the application program, and memory area information to specify the allocated memory area are registered in association with each other, wherein the memory access management unit deletes, from the table, the memory area information of the application program included in the job registered in the table when the job is completed.

### BACKGROUND OF THE INVENTION

1. Field of the Invention

The present invention relates to a semiconductor exposure apparatus, control method, and computer-readable storage medium and, more particularly, to system support by detecting a memory leak in a system.

2. Description of the Related Art

Semiconductor manufacturing includes processes such as silicon ingot cutting, cleaning, deposition, resist coating, exposure, development, etching, resist peeling, assembly, and inspection. Of these processes, the most important technique that determines the degree of integration of a semiconductor is the exposure technique of printing a fine circuit pattern on a wafer. A semiconductor exposure apparatus performs this process. Along with an increase in the degree of integration, driving mechanisms and electronic control components included in semiconductor exposure apparatuses are becoming complex and very precise. The scale of software installed is also becoming larger.

In software programming, a memory area is often allocated as a temporally work area or a data storage area and then freed again when it becomes unnecessary. If the application program has forgotten to free the allocated memory area, the memory area continues to wastefully occupy the memory resource of the system without being used at all. Such a miss in freeing a memory area will be called a memory leak. A memory leak rarely poses a problem in a small-scale system or a system having a short continuous operation time.

However, a semiconductor exposure apparatus generally has a large system scale and continuously operates over a span of several weeks. For this reason, when a memory leak occurs, the performance of the system degrades because of continuous consumption of the memory resource. The system may stop in the worst case. The stop of the semiconductor exposure apparatus greatly affects the whole semiconductor manufacturing process. Hence, the memory leak needs to be resolved.

To resolve the memory leak, some programming languages (e.g., Java® and C#) introduce garbage collection which leaves memory freeing to the operating system. Even for a programming language such as the C language without garbage collection, various methods of resolving a memory leak have been proposed.

For example, Japanese Patent No. 3735484 proposes a method of determining a memory leak area and presenting the result to an operator. In this method, first, when an application program allocates a memory area, the information of the allocated memory area is stored. When freeing the memory area, the corresponding memory area information is deleted. If the ensured memory area information remains at the end of the application program, the memory area is determined as a memory leak area.

Japanese Patent Laid-Open No. 2002-108698 proposes a method of managing the maximum lifetime of a memory area acquired by an application program. A memory area which is not freed even after the elapse of the time is determined as a memory leak area and freed, thereby preventing the memory leak.

A semiconductor exposure apparatus executes a job using a setting file called a recipe, in which an operator or the like has described in advance the exposure process procedure and the exposure parameters, and information such as the number of wafers. A reticle and a wafer are loaded into the semiconductor exposure apparatus and processed. When the process described in the recipe has been performed for the designated number of wafers, the job is completed. To implement the process described in the recipe, in general, a plurality of application programs cooperatively operate in the semiconductor exposure apparatus.

The method disclosed in Japanese Patent No. 3735484 can detect a memory leak of each application program. However, if a plurality of application programs share a single memory area, the method cannot resolve a memory leak.

Assume that an application program A allocates a memory area, and an application program B also refers to and uses the same memory area. If the application program A ends and frees the memory area before the application program B ends, it affects the application program B. To prevent this, the semiconductor exposure apparatus does not free the memory area even at the end of the application program A. However, if the application program B does not free the memory area at the end of the program, a memory leak occurs, and the memory area cannot be used by any application program.

When the above-described method is applied to the application program A, detection of the unfreed memory area can be done as a matter of course. However, this method does not suffice for determining the timing of freeing the memory leak area. When the above-described method is applied to the application program B, no memory leak area is detected because the memory area of interest is not allocated by the application program B itself.

For these reasons, it is difficult to apply the method disclosed in Japanese Patent No. 3735484 to resolve a memory leak in a semiconductor exposure apparatus which sometimes makes a plurality of application programs share a single memory area.

On the other hand, the method disclosed in Japanese Patent Laid-Open No. 2002-108698 manages the maximum lifetime of a memory area acquired by an application program and determines, as a memory leak area, a memory area which is not freed even after the elapse of the time. Even when a plurality of application programs share a memory area, this method can detect a memory leak and free the memory leak area. However, the maximum lifetime is hard to estimate in a semiconductor exposure apparatus which has a long continuous operation time. It is therefore difficult to apply the method disclosed in Japanese Patent Laid-Open No. 2002-108698 to resolve a memory leak in a semiconductor exposure apparatus.

### SUMMARY OF THE INVENTION

The present invention has been made in consideration of the above-described problems, and provides a technique which enables to detect a memory leak in a semiconductor exposure apparatus and free the detected memory leak area.

According to one aspect of the present invention, a semiconductor exposure apparatus which executes a plurality of jobs each including at least one application program is provided. The apparatus includes a memory configured to be used to execute the application program, an application program execution management unit configured to manage execution of the application program included in the job; and a memory access management unit configured to manage a memory area to be allocated to the application program using a table in which the job including the application program, the application program, and memory area information to specify the allocated memory area are registered in association with each other, wherein the memory access management unit deletes, from the table, the memory area information of the application program included in the job registered in the table when the job is completed.

According to another aspect of the present invention, a method of controlling a semiconductor exposure apparatus which executes a plurality of jobs each including at least one application program, and includes a memory used to execute the application program is provided. The method includes managing execution of the application program included in the job by an application program execution management unit; and managing a memory area to be allocated to the application program by a memory access management unit using a table in which the job including the application program, the application program, and memory area information to specify the allocated memory area are registered in association with each other, wherein in managing using the table, the memory area information of the application program included in the job registered in the table is deleted from the table when the job is completed.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of the arrangement according to the first embodiment of the present invention;

FIG. 2 is a flowchart for explaining an example of the main processing of a job according to the first embodiment of the present invention;

FIG. 3 is a flowchart for explaining an example of application program execution processing according to the first embodiment of the present invention;

FIG. 4 is a view showing an example of a job management table in a semiconductor exposure apparatus 10 according to the first embodiment of the present invention;

FIG. 5 is a view showing an example of a memory access management table according to the first embodiment of the present invention;

FIG. 6 is a view showing an example of a memory use management table according to the first embodiment of the present invention; and

FIG. 7 is a block diagram showing an example of the arrangement of a system support apparatus according to the first embodiment of the present invention.

### DESCRIPTION OF THE EMBODIMENTS

Preferred embodiments of the present invention will now be described in detail in accordance with the accompanying drawings. The technical scope of the present invention is not limited by the embodiments.

### First Embodiment

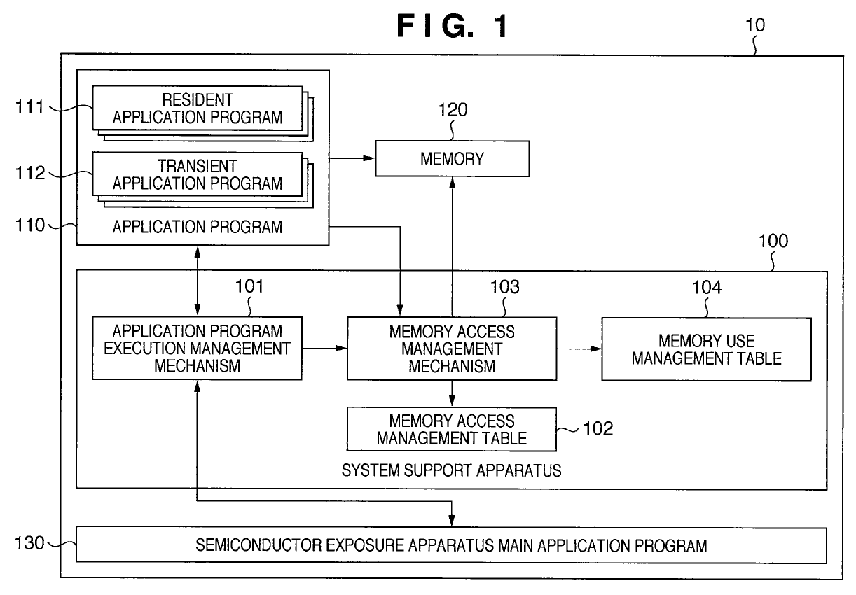

The arrangement of a semiconductor exposure apparatus 10 according to the present invention will be described with reference to FIG. 1. FIG. 1 is a block diagram showing an example of the semiconductor exposure apparatus 10 according to an embodiment of the present invention.

A semiconductor exposure apparatus main application program 130 submits a plurality of jobs to the semiconductor exposure apparatus 10. The plurality of jobs can be submitted to the semiconductor exposure apparatus continuously or simultaneously. A job includes one or more application programs 110. The application programs 110 are classified into resident application programs 111 and transient application programs 112. The difference between them will be described later.

A system support apparatus 100 according to the embodiment of the present invention includes an application program execution management mechanism 101, memory access management table 102, memory access management mechanism 103, and memory use management table 104.

The application program execution management mechanism 101 executes the application programs 110 based on job management information received from the semiconductor exposure apparatus main application program 130. The application programs 110 can be executed in series or in parallel. The application programs 110 may share a single memory area on a memory 120. However, applications belonging to different jobs never share a single memory area on the memory 120. To cause applications belonging to different jobs to share a single memory area on the memory 120, one job that puts the jobs together is defined.

The memory access management table 102 holds information to specify a memory area allocated to each application program 110. The information to specify a memory area will be referred to as memory area information hereinafter.

The memory access management mechanism 103 manages memory area allocation on the memory 120 for each application program 110 and updates the memory access management table 102 in accordance with the memory area allocation state. For example, when a new memory area is allocated to an application program 110, the allocated memory area information is added to the memory access management table 102. When a memory area allocated to an application program 110 is freed, the corresponding memory area information is deleted from the memory access management table 102.

If the memory area information of an memory area allocated to the application programs 110 which were executed by a job remains even after the end of the job, the memory access management mechanism 103 determines the memory area as a memory leak area. Since the job has already ended, the application programs 110 included in the job are not affected even when the memory leak area is freed. The application programs 110 included in another job are not affected by the freeing of the memory leak area, either, because they never use the area. The memory area information corresponding to the memory leak area is deleted from the memory access management table 102, thereby freeing the memory leak area and completely resolving the memory leak by the job.

The memory use management table 104 holds, for each job, the memory leak amount and maximum memory use amount of each application program 110. Calculation of the maximum memory use amount allows to calculate the number of jobs which can be executed simultaneously using the current capacity of the memory 120. It also enables to determine the size of a memory area to be allocated to each application.

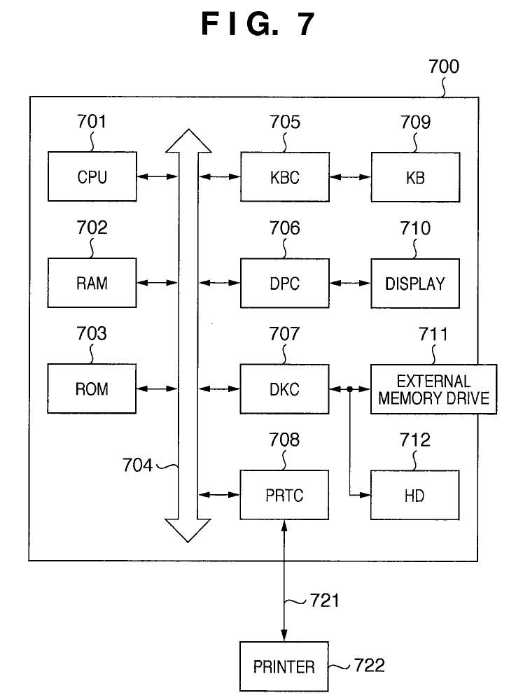

FIG. 7 is a block diagram showing an example of the arrangement of the semiconductor exposure apparatus 10. FIG. 7 illustrates a minimum arrangement to implement the arrangement shown in FIG. 1 corresponding to the embodiment of the present invention. Other mechanisms concerning the semiconductor exposure process are omitted for the descriptive convenience.

A CPU 701 which is a microprocessor controls the semiconductor exposure apparatus 10 based on programs and data stored in a ROM 703, a hard disk (HD) 712, or a storage medium set in an external memory drive 711.

A RAM 702 functions as the work area of the CPU 701 and holds the programs stored in, e.g., the ROM 703 or the HD 712. The RAM 702 also functions as the memory 120 in FIG. 1.

The ROM 703, the storage medium set in the external memory drive 711, or the HD 712 stores programs to be executed by the CPU 701, which are shown in flowcharts to be described later. The application programs 110, the semiconductor exposure apparatus main application program 130, and the job management table are also stored there.

A keyboard controller (KBC) 705 controls input from a keyboard (KB) 709 or a pointing device such as a mouse (not shown). A display controller (DPC) 706 controls display on a display 710. A disk controller (DKC) 707 controls access to the HD 712 or the external memory drive 711, and reads/writes various kinds of programs and various kinds of data such as font data, user files, and editing files from/in the storage medium. A printer controller (PRTC) 708 is connected to a printer 722 via a predetermined bidirectional interface 721 and controls communication with the printer 722.

Note that the CPU 701 executes outline font rasterization processing on a display information area allocated on the RAM 702 or a dedicated video memory (VRAM), thereby enabling display on the display 710. The CPU 701 also opens various kinds of registered windows and executes various kinds of data processing based on commands instructed by, e.g., a mouse cursor on the display 710.

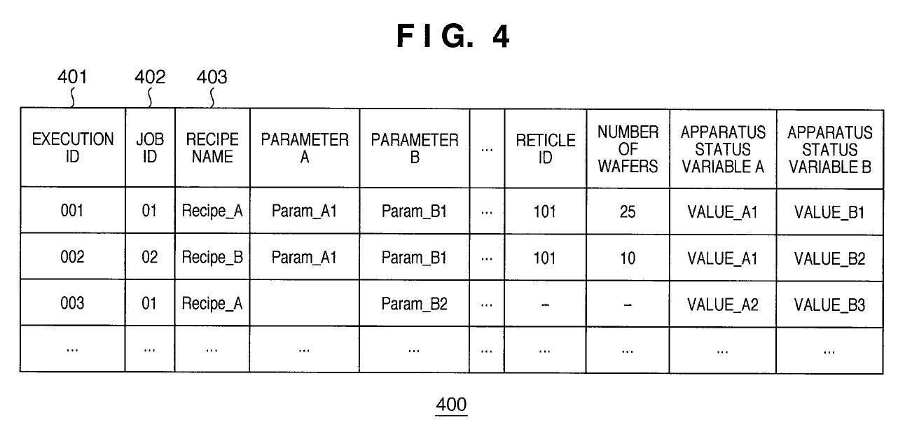

An execution ID 401, job ID 402, and various parameters will be explained with reference to FIG. 4. FIG. 4 shows an example of a job management table 400 in the semiconductor exposure apparatus 10 according to the embodiment of the present invention.

Generally, the semiconductor exposure apparatus 10 holds the job management table 400 as shown in FIG. 4, in which job management information including execution condition values and apparatus status values for execution of a job is registered, and manages the values in correspondence with each execution ID 401.

The execution ID 401 is a number uniquely assigned to each job to be executed. Every time a job is registered in the job management table 400, the semiconductor exposure apparatus main application program 130 assigns the execution ID 401 to the job. The job ID 402 is a number uniquely assigned to each job type. The semiconductor exposure apparatus 10 sometimes executes many jobs having the same job ID 402. The execution IDs 401 are used to distinguish the jobs. For example, in FIG. 4, the jobs having the execution IDs 401 “001” and “003” have the same job ID 402 “01”. The execution IDs 401 are necessary when freeing memory leak areas, as will be described later.

A recipe name 403 is the name of a recipe to be used in a job. A recipe is a file in which an operator or the like has described in advance the exposure process procedure and the exposure parameters. The semiconductor exposure apparatus 10 executes a process by executing a job in which a recipe and information such as the number of wafers are input. When the process described in the recipe has been performed for the designated number of wafers, the job is completed.

The job management information registered in the job management table 400 can also include parameters included in each recipe, a reticle ID, the number of wafers, and state variables. These values are not directly relevant to the actual technical features of the present invention to resolve a memory leak, and a detailed description thereof will be omitted.

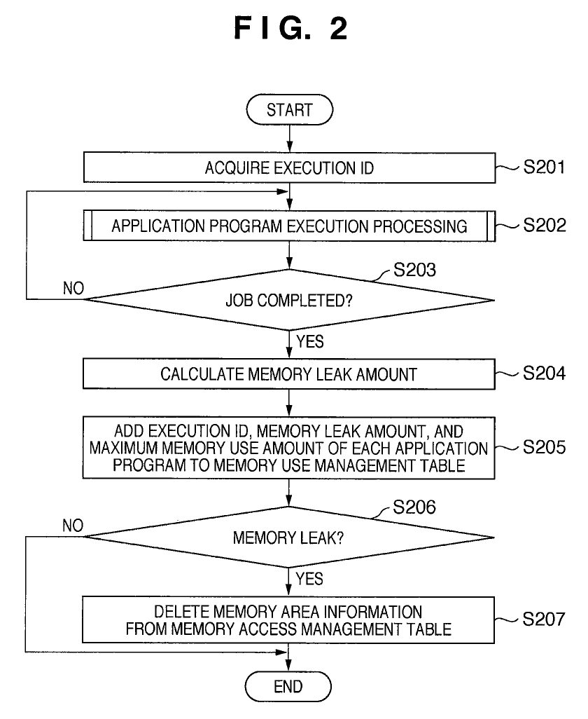

The main processing of the system support apparatus 100 according to this embodiment will be described next with reference to FIG. 2. FIG. 2 is a flowchart for explaining an example of the main processing of a job according to the embodiment of the present invention. The processing shown in this flowchart is implemented by causing the CPU 701 of the semiconductor exposure apparatus 10 to execute a program stored in the RAM 702.

To start a new job, the application program execution management mechanism 101 receives the execution ID of the job from the semiconductor exposure apparatus main application program 130 in step S201. The execution ID reception can be done by, e.g., message communication, and the receiving method is not particularly prescribed. The receiving method is not particularly prescribed even in steps to be described later.

In step S202, the application program execution management mechanism 101 acquires job management information from the job management table 400 based on the received execution ID 401 of the job, and specifies applications to be executed. The application program execution management mechanism 101 executes each specified application program 110. The application program execution processing is repeated until the contents of the recipe corresponding to the execution ID of the job are satisfied.

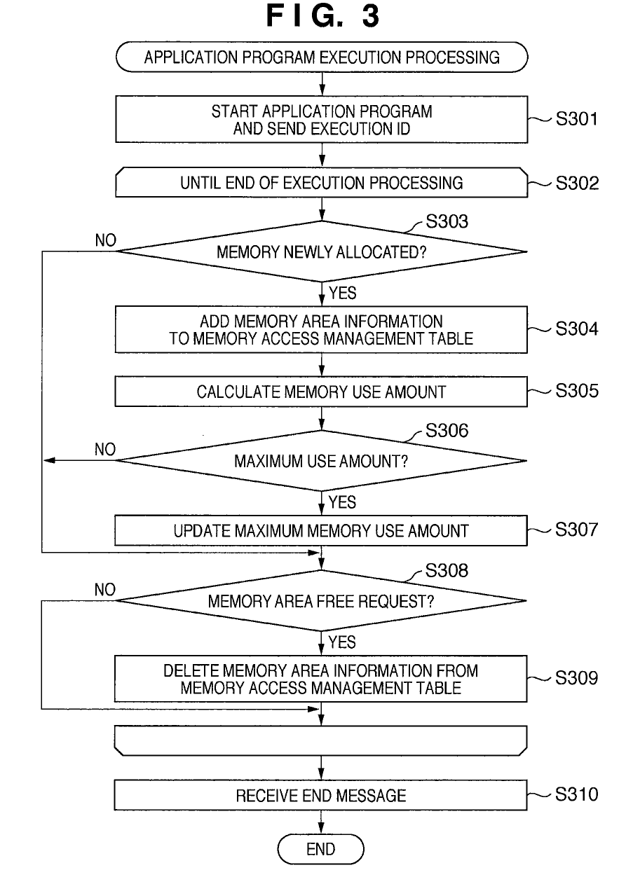

The application program execution processing will be described here using the flowchart shown in FIG. 3. FIG. 3 is a flowchart for explaining an example of the application program execution processing according to the embodiment of the present invention. The processing shown in this flowchart is implemented by causing the CPU 701 of the semiconductor exposure apparatus 10 to execute a program stored in the RAM 702.

In step S301, the application program execution management mechanism 101 starts each application program 110, and notifies each application program 110 of the job ID of the job in which the application program 110 is executed. Since pieces of information necessary for execution are given, including the recipe name 403 and parameter values, as described above, the application program 110 can know the conditions to be set to execute each application program 110.

The application programs 110 to be started include the resident application programs 111 and the transient application programs 112. The resident application program 111 is an application program which is activated together with the semiconductor exposure apparatus 10 and ends when the apparatus stops. Processing execution of the resident application program 111 is triggered by, e.g., the elapse of a time or message reception from another application program 110. On the other hand, the transient application program 112 is an application program 110 which is activated at the start of processing execution of the application program and ends at the end of processing execution. To start processing, the transient application program 112 requires activation of the application program 110.

In step S302, the application program execution management mechanism 101 repeats a series of processes (steps S303 to S309) to update the memory use state until the processing of each running application program 110 ends. If the application program 110 is of a resident type, the end of the processing of the application program 110 is determined upon receiving a processing end message. If the application program 110 is of a transient type, the end of the processing of the application program 110 is determined when it has ended.

In step S303, the memory access management mechanism 103 determines whether a memory area is newly allocated on the memory 120 for the application program 110. If a memory area is allocated (“YES” in step S303), a series of processes (steps S304 to S307) of adding memory area information to the memory access management table 102 is performed.

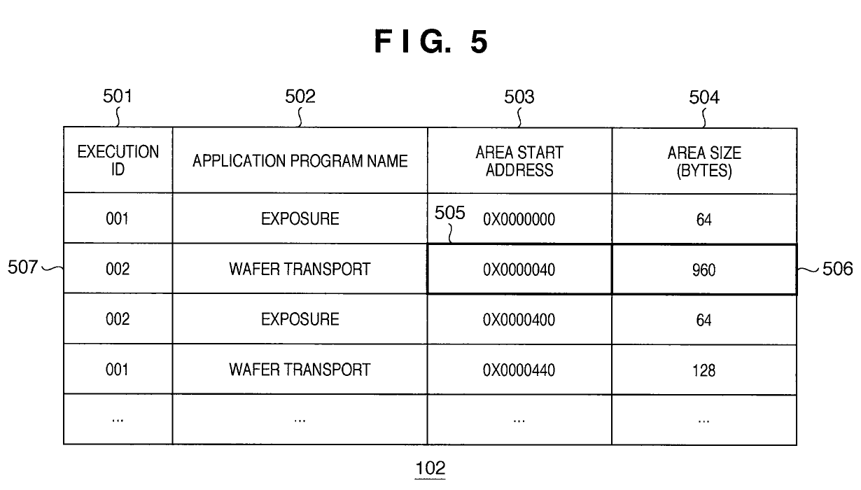

The memory access management table 102 will be explained with reference to FIG. 5. FIG. 5 shows an example of the memory access management table 102 according to the embodiment of the present invention. An execution ID 501, application program name 502, area start address 503, and area size 504 are registered in the memory access management table 102.

The execution ID 501 is the ID of a running job. This value corresponds to the execution ID 401 held in the job management table 400. The application program name 502 is the name of each application program 110 to which a memory area is allocated. For example, in a job having the execution ID 501 “001”, memory areas are allocated to “exposure” and “wafer transport”. The area start address 503 is the start address of a memory area allocated to each application program 110. The area size 504 is the size of a memory area allocated to each application program 110. In this embodiment, the area start address 503 and the area size 504 are used to specify a memory area and therefore serve as memory area information. Note that the memory area information can be any information capable of specifying a memory area.

Referring back to FIG. 3, the series of processes of adding memory area information to the memory access management table 102 will be described below.

In step S304, the memory access management mechanism 103 adds the area start address 503 and the area size 504 to specify the memory area allocated to each application program 110 to the memory access management table 102 together with the execution ID. When allocating a memory area to the application program 110, an area which does not overlap already allocated memory areas is allocated by referring to the memory access management table 102. When the execution ID of the job is also added simultaneously, the memory area information of the allocated memory area is registered in the memory access management table 102 in association with the execution ID. The application program 110 is notified of the job ID in step S301. Hence, when requesting the memory access management mechanism 103 to allocate a memory area, the job ID is also sent to the memory access management mechanism 103 together with the necessary size.

In step S305, the memory access management mechanism 103 calculates the memory use amount of each application program 110 by referring to the memory access management table 102. More specifically, the area sizes 504 of pieces of memory area information which have the same execution ID 501 and the same application program name 502 are added.

In step S306, the memory access management mechanism 103 determines whether the calculated memory use amount is larger than the maximum memory use amount to the application program 110 held in the memory use management table 104. If the memory use amount is larger than the maximum memory use amount (“YES” in step S306), the maximum memory use amount in the memory use management table 104 is updated in step S307. If no maximum memory use amount is stored at all, the calculated memory use amount is stored as the maximum memory use amount. The memory use management table 104 will be described later.

In step S308, the memory access management mechanism 103 determines whether the application program 110 requests to free the memory area allocated to it. If the memory area allocated to an application is referred to by another application, no request to free the memory area is transmitted to the memory access management mechanism 103. This aims at preventing any erroneous end of the processing of another application upon freeing the memory area. In some cases, the processing of an application may end without transmitting a memory area free request to the memory access management mechanism 103. In this embodiment, it is possible to resolve a memory leak which occurs under these circumstances.

To free the memory area (“YES” in step S308), the process advances to step S309. In step S309, memory area information representing the memory area allocated to the application program 110 whose processing has ended is deleted from the memory access management table 102. This enables to allocate the memory area to the application program 110 which has newly requested allocation. Then, if the processing of the application has ended, the process advances to step S310. If the processing of the application has not ended yet, the process returns to step S303 to continue the processing.

Even when the memory area is not to be freed (“NO” in step S308), the process advances to step S310 if the processing of the application has ended. If the processing of the application has not ended yet, the process returns to step S303 to continue the processing.

In step S310, the application program execution management mechanism 101 receives a processing end message from the application program 110.

Referring back to FIG. 2, the explanation of the main processing of the system support apparatus 100 will be continued. Every time one application program execution process in step S202 ends, the application program execution management mechanism 101 receives an application end message from the application program 110. In step S203, the application program execution management mechanism 101 determines based on the number of received end messages whether the running job has completed. This determination can be done by determining whether the number of received end messages matches the number of application executions specified by the recipe of the job management information. If it is determined that the job has completed (“YES” in step S203), the process advances to step S204. If it is determined that the job has not completed yet (“NO” in step S203), the process returns to step S202 to continue the application execution processing.

When completion of the job is confirmed, the memory access management mechanism 103 calculates the memory leak amount from information in the memory access management table 102 based on the execution ID 501 of the completed job in step S204. As described above, a memory area which is not freed even after completion of a job is a memory leak area. The memory area information of a freed memory area is deleted from the memory access management table 102. Hence, remaining memory area information associated with the execution ID represents memory leak information. More specifically, the sum of the area sizes 504 of the application programs 110 corresponding to the execution ID 501 of the completed job is a memory leak amount.

If the information associated with the execution ID does not remain in the memory access management table 102, no memory leak occurs. In this case, the memory leak amount is “0”.

In the example shown in FIG. 5, if memory area information 507 remains even after completion of the job having the execution ID 501 “001”, “wafer transport” executed by the job having the execution ID 501 “001” causes a memory leak. A memory area represented by the memory area information 507 is a memory leak area. On the other hand, when the job having the execution ID 501 “002” is completed, and memory area information including an execution ID “002” and an application program name “wafer transport” is completely deleted, “wafer transport” executed by this job causes no memory leak.

Referring back to FIG. 2, in step S205, the memory access management mechanism 103 adds the calculated memory leak amount of each application program 110 to the memory use management table 104.

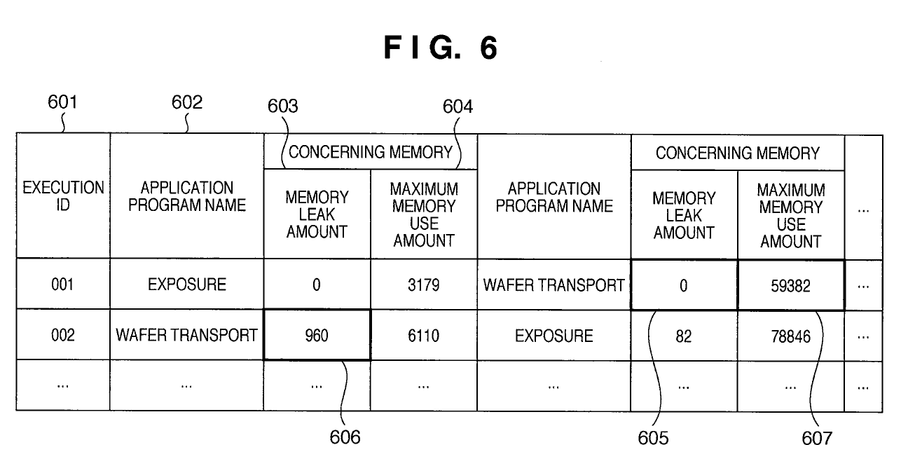

The memory use management table 104 will be described with reference to FIG. 6. FIG. 6 shows an example of the memory use management table according to the embodiment of the present invention. In the memory use management table, an execution ID 601, application program name 602, memory leak amount 603, and maximum memory use amount 604 are registered. The execution ID 601 is the ID of an executed job. This value corresponds to the above-described job ID. The application program name 602 is the name of the executed application program 110.

The memory leak amount 603 is the total size of the memory leak areas of the applications of each job. In the above-described example, since “wafer transport” executed by the job having the execution ID “001” causes no memory leak, “0” is added to a memory leak amount 605 of “wafer transport” of the job. On the other hand, since “wafer transport” executed by the job having the execution ID “002” causes a memory leak of 960 bytes, “960” is added to a memory leak amount 606 of “wafer transport” of the job.

The maximum memory use amount 604 is the maximum size of the memory area allocated to the corresponding application program 110. As described above, the maximum memory use amount is updated successively in step S307. For this reason, the maximum value of the memory area used by the application program 110 until the end of the job is recorded. In the example shown in FIG. 6, a maximum memory use amount 607 of “wafer transport” executed by the job having the execution ID 601 “001” is 59,382 bytes.

As described above, the memory use management table 104 need only manage the memory leak amount 603 and the maximum memory use amount 604 of each application program in correspondence with each execution ID 601. The management contents are not particularly prescribed.

Referring back to FIG. 2, in step S206, the memory access management mechanism 103 determines whether a memory leak has occurred. If a memory leak has occurred (“YES” in step S206), step S207 is executed. If no memory leak has occurred (“NO” in step S206), the main processing of the system support apparatus 100 is ended.

In step S207, the memory access management mechanism 103 deletes, out of the pieces of memory area information, information having the execution ID of the already completed job from the memory access management table 102. In the above-described example shown in FIG. 6, “wafer transport” of the job having the execution ID 601 “002” in the second line has caused a memory leak. Hence, the corresponding memory area information is deleted from the memory access management table 102. After that, the main processing of the system support apparatus 100 is ended.

As described above, the memory area is freed not at the end of the application program 110 but when the job execution is completed. This prevents a memory area shared by the plurality of application programs 110 from being freed erroneously. Additionally, a memory leak area generated upon executing a job is completely resolved.

The memory access management table 102 manages memory area information in correspondence with the execution ID of each job. This allows to free the memory areas of application programs corresponding to only a job having an execution ID of interest. The memory areas of application programs which are being executed by another job are prevented from being freed erroneously.

As described above, according to this embodiment, it is possible to detect a memory leak and free a memory leak area upon completing a job. This prevents the semiconductor exposure apparatus 10 from stopping due to a memory leak and improves the productivity of semiconductor manufacturing. Additionally, since a memory leak amount and a maximum memory use amount are held in correspondence with each application program of individual jobs, the maintenance property of semiconductor manufacturing apparatus software can be improved.

### Second Embodiment

In the first embodiment, the memory access management mechanism 103 manages allocation of the memory 120. However, if a semiconductor exposure apparatus 10 has an existing memory management mechanism without any job identifying function, the present invention can be practiced in cooperation with it.

In this case, upon receiving a memory allocation request from an application program 110, a memory access management mechanism 103 transfers the memory allocation request to the existing memory management mechanism. The memory access management mechanism 103 returns memory area information to the application program 110 as a response and adds the memory area information to a memory access management table 102.

On the other hand, upon receiving a memory free request for the allocated memory area from the application program 110, the memory access management mechanism 103 transfers the memory free request to the existing memory management mechanism. Simultaneously, the memory use management table is deleted from the memory access management table 102.

When the job is completed, the memory access management mechanism 103 regards the memory area of the job which remains in the memory access management table 102 as a memory leak area and requests the existing memory management mechanism to free the memory area.

This arrangement allows to free a memory leak area in cooperation with the existing memory management mechanism even when the memory access management mechanism 103 does not directly manage allocation of the memory 120. This prevents the semiconductor exposure apparatus 10 from stopping due to a memory leak and improves the productivity of semiconductor manufacturing.

### Other Exemplary Embodiments

The above-described exemplary embodiments of the present invention can also be achieved by providing a computer-readable storage medium that stores program code of software (computer program) which realizes the operations of the above-described exemplary embodiments, to a system or an apparatus. Further, the above-described exemplary embodiments can be achieved by program code (computer program) stored in a storage medium read and executed by a computer (CPU or micro-processing unit (MPU)) of a system or an apparatus.

The computer program realizes each step included in the flowcharts of the above-mentioned exemplary embodiments. Namely, the computer program is a program that corresponds to each processing unit of each step included in the flowcharts for causing a computer to function. In this case, the computer program itself read from a computer-readable storage medium realizes the operations of the above-described exemplary embodiments, and the storage medium storing the computer program constitutes the present invention.

Further, the storage medium which provides the computer program can be, for example, a floppy disk, a hard disk, a magnetic storage medium such as a magnetic tape, an optical/magneto-optical storage medium such as a magneto-optical disk (MO), a compact disc (CD), a digital versatile disc (DVD), a CD read-only memory (CD-ROM), a CD recordable (CD-R), a nonvolatile semiconductor memory, a ROM and so on.

Further, an OS or the like working on a computer can also perform a part or the whole of processes according to instructions of the computer program and realize functions of the above-described exemplary embodiments.

In the above-described exemplary embodiments, the CPU jointly executes each step in the flowchart with a memory, hard disk, a display device and so on. However, the present invention is not limited to the above configuration, and a dedicated electronic circuit can perform a part or the whole of processes in each step described in each flowchart in place of the CPU.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-021649, filed Jan. 31, 2008, which is hereby incorporated by reference herein in its entirety.

What is claimed is:

1. A semiconductor exposure apparatus which executes a plurality of jobs each including at least one application program, comprising:
a memory configured to be used to execute the application program;
an application program execution management unit configured to manage execution of the application program included in the job; and
a memory access management unit configured to manage a memory area to be allocated to the application program using a table in which the job including the application program, the application program, and memory area information to specify the allocated memory area are registered in association with each other,
wherein said memory access management unit deletes, from the table, the memory area information of the application program included in the job registered in the table when the job is completed.

2. The apparatus according to claim 1, wherein
said memory access management unit determines whether to free the memory area allocated to the application program, and
if the memory area is to be freed, deletes the memory area information from the table, and if the memory area is not to be freed, leaves the memory area information in the table.

3. The apparatus according to claim 2, wherein said memory access management unit determines whether to free the memory area allocated to the application program based on whether a free request is received from the application program to which the memory area is allocated.

4. The apparatus according to claim 1, further comprising a memory management unit configured to allocate the memory area to the application program,
wherein when deleting, from the table, the memory area information registered in the table, said memory access management unit instructs said memory management unit to cancel the allocation of the memory area corresponding to the memory area information to be deleted.

5. A method of controlling a semiconductor exposure apparatus which executes a plurality of jobs each including at least one application program, and includes a memory used to execute the application program, comprising:
managing execution of the application program included in the job by an application program execution management unit; and
managing a memory area to be allocated to the application program by a memory access management unit using a table in which the job including the application program, the application program, and memory area information to specify the allocated memory area are registered in association with each other,
wherein in managing using the table, the memory area information of the application program included in the job registered in the table is deleted from the table when the job is completed.

6. A storage medium which stores a computer program to cause a computer to execute a control method of claim 5.
